(19) United States
(12) Patent Application Publication
(10) Pub. No.: US 2023/0418110 A1
(43) Pub. Date: Dec. 28, 2023

(54) LIQUID CRYSTAL DISPLAY PANEL AND CURVED DISPLAY DEVICE

(71) Applicant: TCL CHINA STAR OPTOELECTRONICS TECHNOLOGY CO., LTD., Shenzhen (CN)

(72) Inventor: Xinyuan Che, Shenzhen (CN)

(73) Assignee: TCL CHINA STAR OPTOELECTRONICS TECHNOLOGY CO., LTD., Shenzhen (CN)

(21) Appl. No.: 17/272,308

(22) PCT Filed: Dec. 31, 2020
(86) PCT No.: PCT/CN2020/142442

§ 371 Date: Sep. 13, 2023

(30) Foreign Application Priority Data
Dec. 30, 2020 (CN) 202011604649.6

(51) Int. Cl. G02F 1/1337; G02F 1/1347

(52) U.S. Cl. CPC G02F 1/133776; G02F 1/1347; G02F 1/133746; G02F 2201/56

(57) ABSTRACT

The present disclosure provides a liquid crystal display (LCD) panel and a curved display device. The LCD panel includes: a first substrate; a second substrate disposed opposite to the first substrate; and a liquid crystal layer disposed between the first substrate and the second substrate. The liquid crystal layer includes a first liquid crystal layer adjacent to the first substrate and a second liquid crystal layer adjacent to the second substrate. Liquid crystal molecules in the first liquid crystal layer have a first pretilt angle relative to the first substrate, liquid crystal molecules in the second liquid crystal layer have a second pretilt angle relative to the second substrate, and the first pretilt angle and the second pretilt angle are not equal.

### FIELD OF INVENTION

The present disclosure relates to the field of display technologies, and particularly to a liquid crystal display panel and a curved display device.

### BACKGROUND OF INVENTION

Liquid crystal display (LCD) devices, with their advantages such as a thin body, power efficiency, radiation-free, etc., have been widely used and have a dominant position in the field of flat panel displays.

In recent years, with development of LCD technology, major manufacturers have successively introduced curved LCD devices. Ordinary LCD devices have been relatively unsatisfactory in terms of edges of screens, and they have problems such as color shifts, while a curved design of the curved LCD devices provides a wide, panoramic imaging effect. Regardless of whether it is at a center of a screen or around its edges, it can bring good visual enjoyment, and it also reduces distortion of off-axis viewing when viewing at close range. Therefore, on the whole, curved LCD devices can provide the best viewing effect from the center of the screen to the edges of the screen. In addition, curved LCD devices will increase viewing distance of users to achieve a better viewing experience. Therefore, compared to ordinary LCD devices, curved LCD devices have great advantages.

A method of manufacturing a curved LCD device in prior art is to directly apply stress to a flat LCD panel to make the LCD panel present in a curved state. During bending of the LCD panel, due to difference in curvatures of two substrates of the LCD panel, relative positions of the two substrates perpendicular to a light-emitting surface will be displaced, causing misalignment of optical axes of anchored liquid crystal molecules to become larger, and even phenomenon of “fight” of the liquid crystal molecules occurs, which then produces dark clusters, thereby seriously affecting quality of the panels.

Therefore, the prior art has shortcomings which need to be solved urgently.

### SUMMARY OF INVENTION

### Technical Problems

The present disclosure provides an LCD panel and a curved display device to relieve undesirable phenomena such as dark clusters caused by the misalignment of the optical axes of liquid crystal molecules after the LCD panel is bent in the prior art.

### Technical Solutions

To solve the above problems, technical solutions provided by the present disclosure are as follows:

The present disclosure provides an LCD panel, including:
a first substrate;
a second substrate disposed opposite to the first substrate; and
a liquid crystal layer disposed between the first substrate and the second substrate, the liquid crystal layer including a first liquid crystal layer adjacent to the first substrate and a second liquid crystal layer adjacent to the second substrate; and wherein liquid crystal molecules in the first liquid crystal layer have a first pretilt angle relative to the first substrate, liquid crystal molecules in the second liquid crystal layer have a second pretilt angle relative to the second substrate, and the first pretilt angle and the second pretilt angle are not equal.

In the LCD panel of the present disclosure, a difference between the first pretilt angle and the second pretilt angle ranges from 0.5° to 30°; alternatively, the difference between the first pretilt angle and the second pretilt angle ranges from 0.5° to 2° .

In the LCD panel of the present disclosure, one of the first pretilt angle or the second pretilt angle ranges from 60° to 89.5°, and the other one of the first pretilt angle or the second pretilt angle is equal to 90°.

In the LCD panel of the present disclosure, the LCD panel further includes a first alignment film and a second alignment film, the first alignment film is disposed on a side surface of the first substrate adjacent to the first liquid crystal layer, and the second alignment film is disposed on a side surface of the second substrate adjacent to the second liquid crystal layer and is disposed opposite to the first alignment film.

In the LCD panel of the present disclosure, one of the first alignment film or the second alignment film is defined with grooves on a side surface adjacent to the liquid crystal layer, and the pretilt angle of the liquid crystal molecules in one of the first liquid crystal layer or the second liquid crystal layer closer to the grooves is greater than the pretilt angle of the liquid crystal molecules in the other one of the first liquid crystal layer or the second liquid crystal layer.

In the LCD panel of the present disclosure, a depth of each of the grooves is less than or equal to a thickness of the first alignment film or a thickness of the second alignment film.

In the LCD panel of the present disclosure, one of the first substrate or the second substrate is provided with pixel electrodes, an extending direction of each of the grooves is same as an extending direction of each of the pixel electrodes.

In the LCD panel of the present disclosure, one of the first substrate or the second substrate is provided with protrusions on a side surface adjacent to the liquid crystal layer, and the pretilt angle of the liquid crystal molecules in one of the first liquid crystal layer or the second liquid crystal layer closer to the protrusions is greater than the pretilt angle of the liquid crystal molecules in the other one of the first liquid crystal layer or the second liquid crystal layer.

In the LCD panel of the present disclosure, each of the protrusions extends in a strip shape, and a shape of a cross section of each of the protrusions perpendicular to an extending direction of the protrusions is one of a trapezoid, a triangle, or a semicircle.

In the LCD panel of the present disclosure, one of the first substrate or the second substrate is provided with a pixel electrode, the extending direction of the protrusions is same as an extending direction of the pixel electrode.

The present disclosure further provides a curved display device, including a backlight source and an LCD panel, the backlight source connected to the LCD panel to provide backlight for the LCD panel; and
the LCD panel including:
   a first substrate;
   a second substrate disposed opposite to the first substrate; and
   a liquid crystal layer disposed between the first substrate and the second substrate, the liquid crystal layer including a first liquid crystal layer adjacent to the first substrate and a second liquid crystal layer adjacent to the second substrate; and wherein liquid crystal molecules in the first liquid crystal layer have a first pretilt angle relative to the first substrate, liquid crystal molecules in the second liquid crystal layer have a second pretilt angle relative to the second substrate, and the first pretilt angle and the second pretilt angle are not equal.

In the curved display device of the present disclosure, a difference between the first pretilt angle and the second pretilt angle ranges from 0.5° to 30°; alternatively, the difference between the first pretilt angle and the second pretilt angle ranges from 0.5° to 2°.

In the curved display device of the present disclosure, one of the first pretilt angle or the second pretilt angle ranges from 60° to 89.5°, and the other one of the first pretilt angle or the second pretilt angle is equal to 90°.

In the curved display device of the present disclosure, the LCD panel further includes a first alignment film and a second alignment film, the first alignment film is disposed on a side surface of the first substrate adjacent to the first liquid crystal layer, and the second alignment film is disposed on a side surface of the second substrate adjacent to the second liquid crystal layer and is disposed opposite to the first alignment film.

In the curved display device of the present disclosure, one of the first alignment film or the second alignment film is defined with grooves on a side surface adjacent to the liquid crystal layer, and the pretilt angle of the liquid crystal molecules in one of the first liquid crystal layer or the second liquid crystal layer closer to the grooves is greater than the pretilt angle of the liquid crystal molecules in the other one of the first liquid crystal layer or the second liquid crystal layer.

In the curved display device of the present disclosure, a depth of each of the grooves is less than or equal to a thickness of the first alignment film or a thickness of the second alignment film.

In the curved display device of the present disclosure, one of the first substrate or the second substrate is provided with pixel electrodes, an extending direction of each of the grooves is same as an extending direction of each of the pixel electrodes.

In the curved display device of the present disclosure, one of the first substrate or the second substrate is provided with protrusions on a side surface adjacent to the liquid crystal layer, and the pretilt angle of the liquid crystal molecules in one of the first liquid crystal layer or the second liquid crystal layer closer to the protrusions is greater than the pretilt angle of the liquid crystal molecules in the other one of the first liquid crystal layer or the second liquid crystal layer.

In the curved display device of the present disclosure, each of the protrusions extends in a strip shape, and a shape of a cross section of each of the protrusions perpendicular to an extending direction of the protrusions is one of a trapezoid, a triangle, or a semicircle.

In the curved display device of the present disclosure, one of the first substrate or the second substrate is provided with a pixel electrode, the extending direction of the protrusions is same as an extending direction of the pixel electrode.

### Beneficial Effects

Beneficial effects of the present disclosure are: in the LCD panel and the curved display device provided by the present disclosure, the pretilt angles of the liquid crystal molecules in the first liquid crystal layer close to the first substrate and the second liquid crystal layer close to the second substrate are designed, and there is a difference between the two pretilt angles, so after the LCD panel is bent, the optical axes of the liquid crystal molecules will not produce undesirable phenomena such as dark clusters due to misalignment.

### DESCRIPTION OF DRAWINGS

Following describes specific implementations of the present disclosure in detail with reference to accompanying drawings, which will make the technical solutions and other beneficial effects of the present disclosure obvious.

FIG. 1 is a schematic structural view of a liquid crystal display (LCD) panel in a planar state in the prior art.

FIG. 2 is a schematic view showing a partial structure of a curved portion of the LCD panel shown in FIG. 1 in a curved state.

FIG. 3 is a schematic structural view of an LCD panel provided by the present disclosure in a planar state.

FIG. 4 is a schematic view showing a partial structure of a curved portion of the LCD panel shown in FIG. 3 in a curved state.

FIG. 5 is a schematic structural view of another LCD panel in a planar state in the prior art.

FIG. 6 is a schematic view showing a partial structure of a curved portion of the LCD panel shown in FIG. 5 in a curved state.

FIG. 7 is a schematic structural view of another LCD panel provided by the present disclosure in a planar state.

FIG. 8 is a schematic view showing a partial structure of a curved portion of the LCD panel shown in FIG. 7 in a curved state.

FIG. 9 is a schematic structural view of an LCD panel provided by a first embodiment of the present disclosure.

FIG. 10 is a top view of a first substrate provided by the first embodiment of the present disclosure.

FIG. 11 is a schematic structural view of an LCD panel provided by a second embodiment of the present disclosure.

FIG. 12 is a top view of a second substrate provided by the second embodiment of the present disclosure.

### DETAILED DESCRIPTION OF EMBODIMENTS

The technical solutions in the embodiments of the present disclosure will be clearly and completely described with reference to the accompanying drawings in the embodiments of the present disclosure. Obviously, the described embodiments are only a part of the embodiments of the present disclosure, but not all the embodiments. Based on the embodiments in the present disclosure, all other embodiments obtained by those skilled in the art without creative work fall into protection scope of the present disclosure.

In the description of the present disclosure, it should be understood that the terms “longitudinal”, “lateral”, “length”, “width”, “upper”, “lower”, “front”, “rear”, “left” “,” “right”, “vertical”, “horizontal”, etc. indicate orientations or positional relationships based on the orientation or positional relationships shown in the drawings, and are only for convenience of describing the present disclosure and simplifying the description, rather than indicating or implying the device or element referred to must have a specific orientation, be constructed and operated in a specific orientation, and therefore cannot be understood as a limitation of the present disclosure. Additionally, the terms “first”, “second” are only used for descriptive purposes, and cannot be understood as indicating or implying relative importance or implicitly indicating the number of indicated technical features. Therefore, the features defined with “first” and “second” may explicitly or implicitly include one or more of the features. In the description of the present disclosure, “plurality” means two or more than two, unless specifically defined otherwise.

The present disclosure may repeat reference numbers and/or reference letters in different examples, and this repetition is for a purpose of simplification and clarity, and does not indicate the relationship between the various embodiments and/or settings discussed.

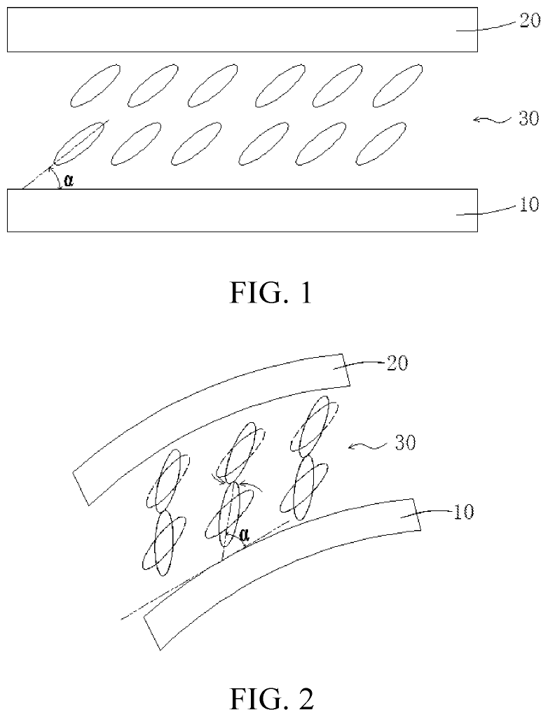

As shown in FIG. 1, the liquid crystal display (LCD) panel in the prior art includes a first substrate 10, a second substrate 20, and a liquid crystal layer 30 disposed between the first substrate 10 and the second substrate 20. After the LCD panel is energized, all liquid crystal molecules in the liquid crystal layer 30 are deflected under the effect of an electric field, and their deflection directions and deflection angles are same, i.e.., when the LCD panel is in a planar state, pretilt angles a of all liquid crystal molecules (herein, the pretilt angles of liquid crystal molecules refer to tilt angles of the long axis of the liquid crystal molecules with respect to the first substrate or the second substrate) are equal, so that brightness of different areas of the LCD panel are consistent, and there is no uneven brightness.

However, when manufacturing a curved LCD panel, the first substrate 10 and the second substrate 20 are in a curved state, as shown in FIG. 2, FIG. 2 is a schematic view showing a partial structure of a curved portion of the LCD panel shown in FIG. 1 in a curved state. Since the first substrate 10 and the second substrate 20 produce a relative displacement in a curved area, the liquid crystal layer 30 sandwiched between the first substrate 10 and the second substrate 20 will also produce a relative displacement. Since an alignment film on the first substrate 10 and an alignment film on the second substrate 20 have an anchoring force on the liquid crystal molecules adjacent to them, to ensure a tilt angle of the liquid crystal molecules close to the first substrate 10 relative to the first substrate 10 and a tilt angle of the liquid crystal molecules close to the second substrate 20 relative to the second substrate 20 remain unchanged, the liquid crystal molecules close to the first substrate 10 and the liquid crystal molecules close to the second substrate 20 will deflect in opposite directions (as shown by arrows in FIG. 2). In this way, the pretilt angle of the liquid crystal molecules in the curved area of the curved LCD panel is guaranteed to be α, and the deflection angle of the liquid crystal molecules in the curved area of the curved LCD panel and a deflection angle of the liquid crystal molecules in a non-curved area of the curved LCD panel are same. During this process, the liquid crystal molecules close to the first substrate 10 and the liquid crystal molecules close to the second substrate 20 are prone to “fight” during the deflection process, causing dark lines or dark clusters in the curved LCD panel corresponding to the curved area, and undesirable phenomena occurs.

In order to solve the technical problem that when manufacturing curved liquid crystal display panels in the prior art, a difference in curvatures of two substrates of the LCD panel would cause relative positions of the two substrates perpendicular to a light-emitting surface to be displaced, causing misalignment of optical axes of anchored liquid crystal molecules to become larger, thereby causing technical problems such as dark clusters, this embodiment of the present disclosure provides a liquid crystal display panel. For details, refer to the following embodiment.

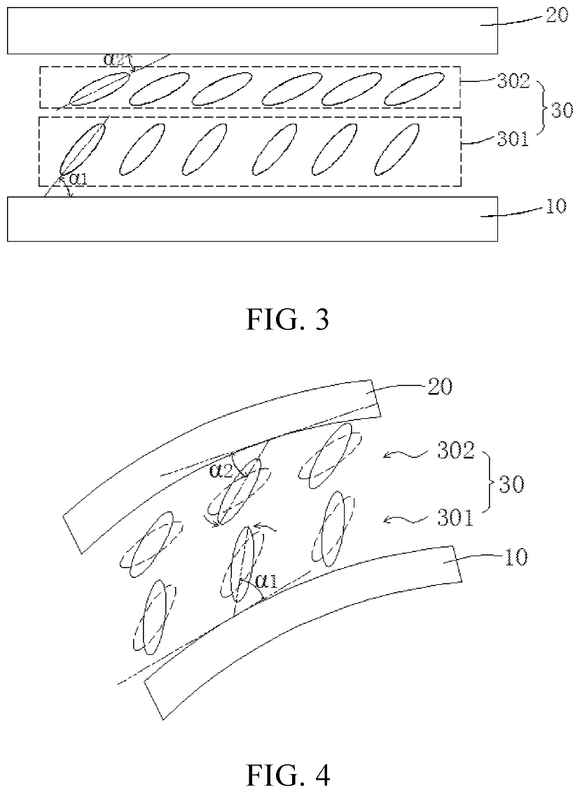

FIG. 3 is a schematic structural view of an LCD panel provided by the present disclosure in a planar state. As shown in FIG. 3, the LCD panel includes a first substrate 10, a second substrate 20, and a liquid crystal layer 30 disposed between the first substrate 10 and the second substrate 20.

As an embodiment, the first substrate 10 is an array substrate. The first substrate 10 is provided with crisscrossing scan lines and data lines and pixel units defined by intersections of scan lines and data lines. The second substrate 20 is a color filter substrate. The second substrate 20 is provided with grid-shaped black matrixes and an RGB color resist layer located between the black matrixes. The RGB color resist layer corresponds to the pixel units. Wherein, at least one of the first substrate 10 or the second substrate 20 is provided with an alignment film on a side close to the liquid crystal layer 30. As another embodiment, the first substrate 10 is a color filter substrate, and the second substrate 20 is an array substrate.

The liquid crystal layer 30 includes a first liquid crystal layer 301 adjacent to the first substrate 10 and a second liquid crystal layer 302 adjacent to the second substrate 20. Liquid crystal molecules in the first liquid crystal layer 301 have a first pretilt angle α1 relative to the first substrate 10, and liquid crystal molecules in the second liquid crystal layer 20 have a second pretilt angle α2 relative to the second substrate 20, wherein the first pretilt angle α1 and the second pretilt angle α2 are different, i.e., they are not equal.

Furthermore, a difference between the first pretilt angle α1 and the second pretilt angle α2 ranges from 0.5° to 30°.

FIG. 4 is a schematic view showing a partial structure of a curved portion of the LCD panel shown in FIG. 3 in a curved state. As shown in FIG. 4, when the LCD panel in FIG. 3 is configured to fabricate a curved LCD panel, since the first substrate 10 and the second substrate 20 have a relative displacement in the curved area, the first liquid crystal layer 301 and the second liquid crystal layer 302 also have a relative displacement. During the bending process of the LCD panel, the first liquid crystal layer 301 and the second liquid crystal layer 302 in the curved area will move accordingly with the relative displacement of the first substrate 10 and the second substrate 20, i.e., the liquid crystal molecules in the first liquid crystal layer 301 and the liquid crystal molecules in the second liquid crystal layer 302 appear to be deflected in opposite directions in the curved area of the LCD panel (as shown by the arrow in FIG. 4). In this way, the pretilt angle of the liquid crystal molecules in the first liquid crystal layer 301 in the curved area is guaranteed to be α1, and the pretilt angle of the liquid crystal molecules in the second liquid crystal layer 302 is guaranteed to be α2, so that the deflection angle of the liquid crystal molecules in the curved area of the LCD panel and the deflection angle of the liquid crystal molecules in the non-curved area are consistent. During this process, the difference between the first pretilt angle al and the second pretilt angle α2 ranges from 0.5° to 30°, so during the process of bending the LCD panel in a planar state, the phenomenon of “fighting” between the liquid crystal molecules in the first liquid crystal layer 301 corresponding to the curved area and the liquid crystal molecules in the second liquid crystal layer 302 corresponding to the curved area can be prevented, thereby preventing occurrence of dark lines or dark clusters in the LCD panel corresponding to the curved area and improving brightness uniformity of the curved LCD panel. Specifically, the angle difference between the first pretilt angle α1 and the second pretilt angle α2 may be set according to a curvature of the LCD panel.

Furthermore, the difference between the first pretilt angle al and the second pretilt angle α2 ranges from 0.5° to 2°. If the angle difference between the first pretilt angle al and the second pretilt angle α2 is within this range, the phenomenon of “fight” between the liquid crystal molecules in the first liquid crystal layer 301 and the second liquid crystal layer 302 can be avoided.

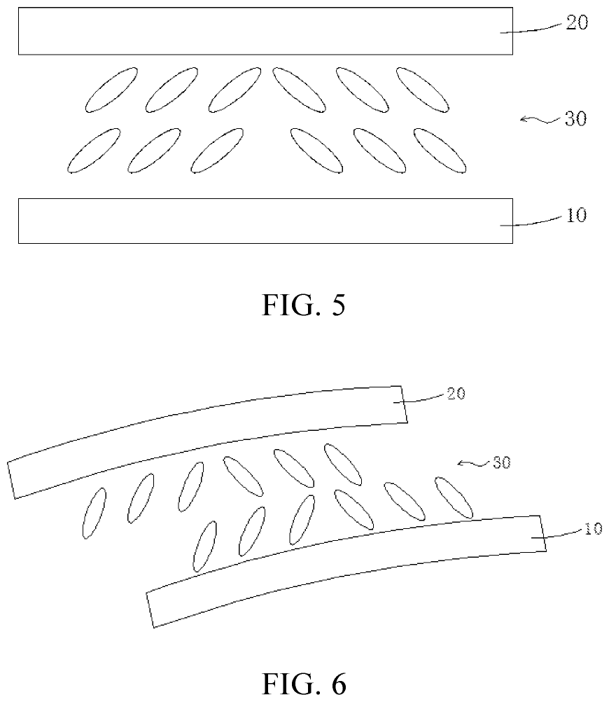

In order to improve the display effect at large viewing angles, the LCD panel in the prior art usually adopts a multi-domain pixel unit structure, such as a four-domain pixel structure, an eight-domain pixel structure, etc., and there are different liquid crystal alignment areas corresponding to different domains. Specifically, FIG. 5 is a schematic structural view of another LCD panel in a planar state in the prior art. As shown in FIG. 5, the LCD panel includes a first substrate 10, a second substrate 20, and a liquid crystal layer 30 disposed between the first substrate 10 and the second substrate 20. Since the liquid crystal alignments of two adjacent liquid crystal alignment areas are different, dark lines are generally present in an alignment transition area between the two adjacent liquid crystal alignment areas. As shown in FIG. 6, when the LCD panel in FIG. 5 is configured to fabricate a curved LCD panel, the first substrate 10 and the second substrate 20 are in a curved state, and since the first substrate 10 and the second substrate 20 have a relative displacement in the curved area, the liquid crystal layer 30 sandwiched between the first substrate 10 and the second substrate 20 also has a relative displacement. At an edge position of a same liquid crystal alignment area, the tilt angle of the liquid crystal molecules close to the first substrate 10 relative to the first substrate 10 and the tilt angle of the liquid crystal molecules close to the second substrate 20 relative to the second substrate 20 remain unchanged, but the deflection directions are opposite. Herein, after the liquid crystal molecules close to the first substrate 10 and the liquid crystal molecules close to the second substrate 20 are superimposed, dark lines will appear, which enlarges an area of dark lines and causes uneven brightness.

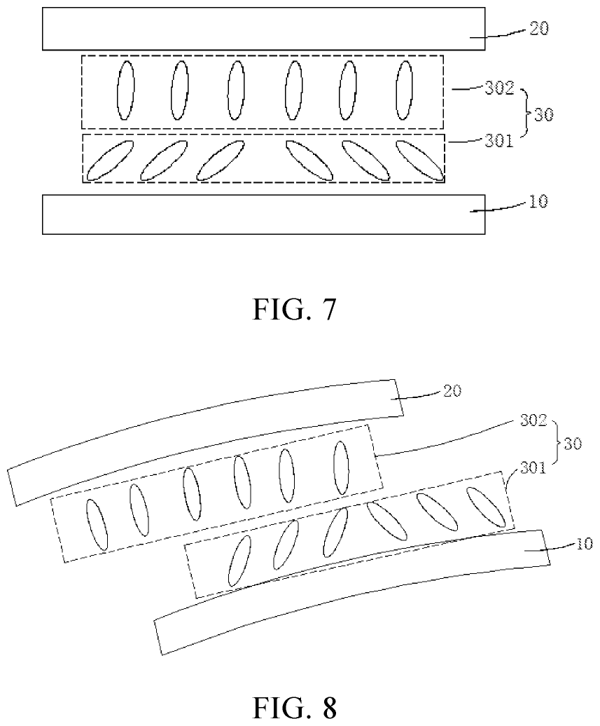

As shown in FIG. 7, FIG. 7 is a schematic structural view of another LCD panel provided by the present disclosure in a planar state. The LCD panel includes a first substrate 10, a second substrate 20, and a liquid crystal layer 30. The liquid crystal layer 30 includes a first liquid crystal layer 301 adjacent to the first substrate 10 and a second liquid crystal layer 302 adjacent to the second substrate 20. Liquid crystal molecules in the first liquid crystal layer 301 form a first pretilt angle relative to the first substrate 10, and liquid crystal molecules in the second liquid crystal layer 20 form a second pretilt angle relative to the second substrate 20, wherein one of the first pretilt angle or the second pretilt angle ranges from 60° to 89.5°, and the other one of the first pretilt angle or the second pretilt angle is equal to 90° . For example, the first pretilt angle corresponding to one of the liquid crystal alignment areas may be 70°, 75°, 80° or 85°. In this embodiment, the first pretilt angle of 60°-89.5° and the second pretilt angle of 90° are used as examples for description.

In the present disclosure, the first pretilt angle is the angle between a long axis direction of the liquid crystal molecules in the first liquid crystal layer 301 and a plane where the first substrate 10 is located, and the second pretilt angle is the angle between a long axis direction of the liquid crystal molecules in the second liquid crystal layer 302 and a plane where the second substrate 20 is located.

As shown in FIG. 8, when the LCD panel in FIG. 7 is configured to fabricate a curved LCD panel, the first substrate 10 and the second substrate 20 have a relative displacement, the first liquid crystal layer 301 and the second liquid crystal layer 302 have a relative displacement, arrangement directions of the liquid crystal molecules in the first liquid crystal layer 301 and the second liquid crystal layer 302 remain unchanged, so the first pretilt angle and the second pretilt angle remain unchanged before and after the LCD panel is bent. Since the second pretilt angle of the liquid crystal molecules in the second liquid crystal layer 302 remains unchanged at 90°, and even if a direction of the first pretilt angle of the first liquid crystal layer 301 is different, it will not cause the first pretilt angle and the second pretilt angle superimposed on each other to generate dark clusters and will not cause the phenomenon of uneven brightness occurring, thereby relieving the problem of uneven brightness of the curved LCD panel.

In the prior art, pretilt angles of liquid crystal layers in the LCD panel can be differentiated in the following ways: The first is to form different types of alignment films on the first substrate and the second substrate to generate different pretilt angles, but liquid needs to be changed when preparing the alignment films, which would greatly compromise production capacity. The second is to coat an alignment film on one side of the substrate and not to coat the other side with alignment film. Different pretilt angles can also be formed on both sides; however, this method has poor reliability and high material costs. In the present disclosure, grooves or protrusions are formed on a single-sided substrate to create a difference in pretilt angles of the liquid crystal layer, thereby relieving dark clusters of the curved surface.

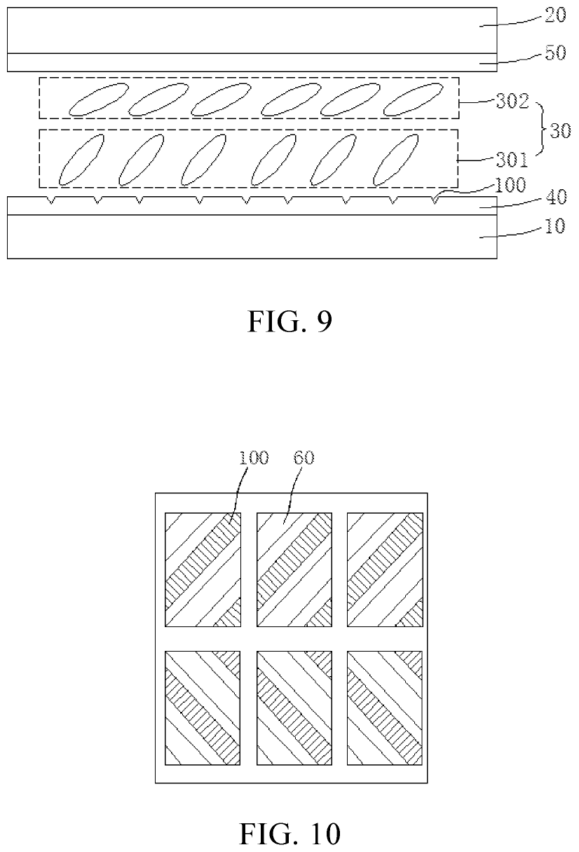

Specifically, as shown in FIG. 9, which is a schematic structural view of an LCD panel provided by a first embodiment of the present disclosure, the LCD panel includes a first substrate 10, a first alignment film 40, a second substrate 20, a second alignment film 50, and a liquid crystal layer 30. The first alignment film 40 is disposed on a side surface of the first substrate 10 adjacent to the first liquid crystal layer 30, the second alignment film 50 is disposed on a side surface of the second substrate 20 adjacent to the second liquid crystal layer 30, and the first alignment film 40 and the second alignment film 50 are opposite to each other. The liquid crystal layer 30 includes a first liquid crystal layer 301 adjacent to the first substrate 10 and a second liquid crystal layer 302 adjacent to the second substrate 20, wherein the first substrate 10 is an array substrate, and the second substrate 20 is a color filter substrate.

In this embodiment, the first alignment film 40 and the second alignment film 50 are made of a same material, and the material may be, but is not limited to, a polyimide material.

As shown in FIG. 9, the first alignment film 40 is defined with grooves 100 on a side surface close to the first liquid crystal layer 301. Arrangement of the grooves 100 makes the pretilt angle of the liquid crystal molecules in the first liquid crystal layer 301 larger than the pretilt angle of the liquid crystal molecules in the second liquid crystal layer 302.

Furthermore, a difference between the pretilt angle of the liquid crystal molecules in the first liquid crystal layer 301 and the pretilt angle of the liquid crystal molecules in the second liquid crystal layer 302 ranges from 0.5° to 30°.

When the LCD panel in FIG. 9 is configured to fabricate a curved LCD panel, since the first substrate 10 and the second substrate 20 have a relative displacement in the curved area, the first liquid crystal layer 301 and the second liquid crystal layer 302 also have a relative displacement. During the bending process of the LCD panel, the first liquid crystal layer 301 and the second liquid crystal layer 302 in the curved area will move accordingly with the relative displacement of the first substrate 10 and the second substrate 20, i.e., the liquid crystal molecules in the first liquid crystal layer 301 and the liquid crystal molecules in the second liquid crystal layer 302 deflect in opposite directions in the curved area of the LCD panel, thereby making the deflection angle of the liquid crystal molecules in the curved area of the LCD panel and the deflection angle of the liquid crystal molecules in the non-curved area same. During this process, the difference between the first pretilt angle of the liquid crystal molecules in the first liquid crystal layer 301 and the second pretilt angle of the liquid crystal molecules in the second liquid crystal layer 302 ranges from 0.5° to 30°, so during the process of bending the LCD panel in a planar state, the phenomenon of “fighting” between the liquid crystal molecules in the first liquid crystal layer 301 and the second liquid crystal layer 302 corresponding to the curved area can be prevented, thereby preventing the occurrence of dark lines or dark clusters in the LCD panel corresponding to the curved area and improving brightness uniformity of the curved LCD panel.

In an embodiment, a depth of the grooves 100 may be less than a thickness of the first alignment film 40.

In another embodiment, the depth of the grooves 100 may be set equal to the thickness of the first alignment film 40, i.e., the grooves 100 divide the first alignment film 40 into a plurality of stripes, and each of the grooves 100 is formed between two adjacent strip-shaped alignment films.

In a process of preparing the LCD panel, after the first alignment film 40 is formed on the first substrate 10, the first alignment film 40 is cured, and after curing the first alignment film 40, a rubbing cloth is used to perform a rubbing process on a surface of the first alignment film 40 to form grooves 100 on the surface of the first alignment film 40. A second alignment film 50 is prepared on a side surface of the second substrate 20 close to the first substrate 10, a sealant is prepared on the side of the second substrate 20 close to the first substrate 10, and then, a liquid crystal material is prepared on the first alignment film 40. Then, the first substrate 10 and the second substrate 20 are bonded together, and the sealant is cured to form the LCD panel. The LCD panel is sent into an ultraviolet light cavity, a voltage is applied first, and then ultraviolet light is irradiated to align the liquid crystal molecules in the first liquid crystal layer 301 and the second liquid crystal layer 302 to form the first pretilt angle and the second pretilt angle respectively. Finally, the LCD panel is sent into an unpowered ultraviolet light cavity to be irradiated, so that the reactive monomers in the alignment films are completely reacted, and an entire manufacturing process of the LCD panel is completed.

It can be understood that in another embodiment, grooves 100 may be provided on a side surface of the second alignment film 50 close to the second liquid crystal layer 302. The pretilt angle of the liquid crystal molecules in the second liquid crystal layer 302 is greater than the pretilt angle of the liquid crystal molecules in the first liquid crystal layer 301.

Structures and formation of the grooves 100 provided on the second alignment film 50 are the same as structures and formation of the grooves 100 provided on the first alignment film 40. Please refer to the above-mentioned description, which will not be repeated herein.

As shown in FIG. 10, in this embodiment, one of the first substrate 10 or the second substrate 20 is provided with pixel electrodes 60, the pixel electrodes 60 are arranged in a strip shape, and an extending direction of the grooves 100 may be the same as an extension direction of the pixel electrode 60.

Wherein, since the grooves 100 are defined on the surface of the first alignment film 40, the first pretilt angle of the first liquid crystal layer 301 is greater than the second pretilt angle of the second liquid crystal layer 302, thereby realizing differentiation of pretilt angles of the liquid crystal layer in the LCD panel. In this embodiment, since materials of the first alignment film 40 and the second alignment film 50 are same, the liquid crystal display panel of the embodiment takes up less capacity and has a lower cost.

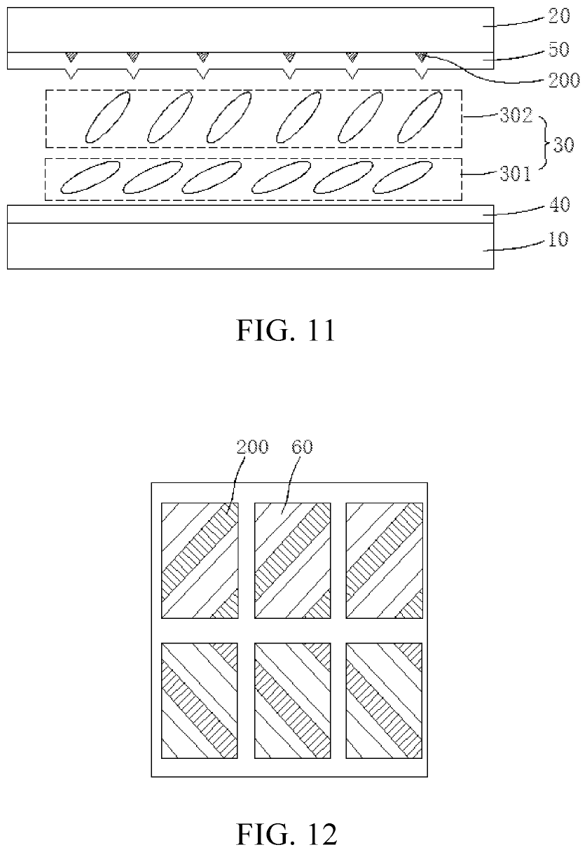

As shown in FIG. 11, which is a schematic structural view of an LCD panel provided by a second embodiment of the present disclosure, a structure of the embodiment is similar to the structure of the LCD panel of the above-mentioned first embodiment except that in the embodiment, one of the first substrate 10 or the second substrate 20 is provided with protrusions 200 on a side surface close to the liquid crystal layer 30, and surfaces of the first alignment film 40 and the second alignment film 50 do not need to be defined with the grooves 100 as in the above-mentioned first embodiment. In addition, a pretilt angle of the liquid crystal molecules in one of the first liquid crystal layer 301 or the second liquid crystal layer 302 close to the protrusions 200 is greater than a pretilt angle of the liquid crystal molecules in the other one.

In this embodiment, the first alignment film 40 and the second alignment film 50 are made of a same material, which may be, but is not limited to, a polyimide material.

In this embodiment, the protrusions 200 are provided on the second substrate 20. Specifically, in the process of preparing the LCD panel, a process of vapor deposition of convex patterns is added after the black matrixes and RGB color resist layer are prepared on the second substrate 20 and before the electrode layer is evaporated onto the second substrate 20. Then, patterning is performed to form a plurality of protrusions 200 on the second substrate 20. Then, an electrode layer is evaporated onto the second substrate 20, and the electrode layer is patterned to form a plurality of electrodes. The electrodes may be pixel electrodes or common electrodes. Each of the protrusions 200 extends in a strip shape, and a shape of a cross section of each of the protrusions 200 perpendicular to an extending direction of the protrusions 200 is, but is not limited to, one of a trapezoid, a triangle, or a semicircle.

The first alignment film 40 and the second alignment film 50 are respectively prepared on the first substrate 10 and the second substrate 20 and the first alignment film 40 and the second alignment film 50 are cured. A sealant is prepared on the side of the second substrate 20 close to the first substrate 10, and then, a liquid crystal material is prepared on the first alignment film 40. The first substrate 10 and the second substrate 20 are bonded together, and the sealant is cured to form an LCD panel. The LCD panel is sent into an ultraviolet light cavity, wherein a voltage is applied first, and then ultraviolet light is irradiated to align the liquid crystal molecules in the first liquid crystal layer 301 and the second liquid crystal layer 302 to form the first pretilt angle and the second pretilt angle respectively. Finally, the LCD panel is sent into an unpowered ultraviolet light cavity to be irradiated, so that the reactive monomers in the alignment films are completely reacted, and an entire manufacturing process of the LCD panel is completed. As shown in FIG. 12, in this embodiment, one of the first substrate 10 or the second substrate 20 is provided with pixel electrodes 60, the pixel electrodes 60 are arranged in a strip shape, and an extending direction of the protrusions 200 may be same as an extending direction of the pixel electrodes 60.

Since the protrusions 200 are provided on a side of the second substrate 20, a trench-like structure is formed between two adjacent protrusions 200, thereby realizing differentiation of the pretilt angles of the liquid crystal layer in the LCD panel. In this embodiment, since the materials of the first alignment film 40 and the second alignment film 50 are same, the liquid crystal display panel of this embodiment takes up less capacity and has a lower cost.

In another embodiment, the first substrate 10 is provided with the protrusions 200, wherein, a structure and a formation method of the protrusions 200 provided on the first substrate 10 are same as a structure and a formation method of the protrusions 200 provided on the second substrate 20. Please refer to the above-mentioned description, which will not be repeated herein.

The liquid crystal display panel of the present disclosure may be, but is not limited to, a vertical alignment-type (VA) liquid crystal display panel.

The present disclosure further provides a curved display device, which includes a backlight source and the liquid crystal display panel in any of the above-mentioned embodiments, and the backlight source is connected to the liquid crystal display panel to provide backlight to the liquid crystal display panel.

In the liquid crystal display panel and the curved display device provided by the present disclosure, the pretilt angle of the liquid crystal molecules in the first liquid crystal layer close to the first substrate and the pretilt angle of the liquid crystal molecules in the second liquid crystal layer close to the second substrate are designed to be different, so that after the liquid crystal display panel is bent, the optical axes of the liquid crystal molecules would not have problems such as dark clusters due to misalignment.

In addition, the LCD panel and the curved display device provided by the present disclosure realize differentiation of the pretilt angle of the liquid crystal molecules in the first liquid crystal layer close to the first substrate and the pretilt angle of the liquid crystal molecules in the second liquid crystal layer close to the second substrate by forming grooves or protrusions on the single-sided substrate of the LCD panel. The process is simple and the cost is low.

In summary, although the present disclosure has been disclosed as above in preferred embodiments, the above-mentioned preferred embodiments are not intended to limit the present disclosure. Those of ordinary skills in the art, without departing from the spirit and scope of the present disclosure, various changes and modifications can be made, so the protection scope of the present disclosure is subject to the scope defined by the claims.

1. A liquid crystal display (LCD) panel, comprising:
a first substrate;
a second substrate disposed opposite to the first substrate; and
a liquid crystal layer disposed between the first substrate and the second substrate, the liquid crystal layer comprising a first liquid crystal layer adjacent to the first substrate and a second liquid crystal layer adjacent to the second substrate; and
wherein liquid crystal molecules in the first liquid crystal layer have a first pretilt angle relative to the first substrate, liquid crystal molecules in the second liquid crystal layer have a second pretilt angle relative to the second substrate, and the first pretilt angle and the second pretilt angle are not equal.

2. The LCD panel according to claim 1, wherein a difference between the first pretilt angle and the second pretilt angle ranges from 0.5° to 30°; alternatively, the difference between the first pretilt angle and the second pretilt angle ranges from 0.5° to 2°.

3. The LCD panel according to claim 1, wherein one of the first pretilt angle or the second pretilt angle ranges from 60° to 89.5°, and the other one of the first pretilt angle or the second pretilt angle is equal to 90°.

4. The LCD panel according to claim 1, further comprising a first alignment film and a second alignment film, wherein the first alignment film is disposed on a side surface of the first substrate adjacent to the first liquid crystal layer, and the second alignment film is disposed on a side surface of the second substrate adjacent to the second liquid crystal layer and is disposed opposite to the first alignment film.

5. The LCD panel according to claim 4, wherein one of the first alignment film or the second alignment film is defined with grooves on a side surface adjacent to the liquid crystal layer, and the pretilt angle of the liquid crystal molecules in one of the first liquid crystal layer or the second liquid crystal layer closer to the grooves is greater than the pretilt angle of the liquid crystal molecules in the other one of the first liquid crystal layer or the second liquid crystal layer.

6. The LCD panel according to claim 5, wherein a depth of each of the grooves is less than or equal to a thickness of the first alignment film or a thickness of the second alignment film.

7. The LCD panel according to claim 5, wherein one of the first substrate or the second substrate is provided with pixel electrodes, and an extending direction of each of the grooves is same as an extending direction of each of the pixel electrodes.

8. The LCD panel according to claim 4, wherein one of the first substrate or the second substrate is provided with protrusions on a side surface adjacent to the liquid crystal layer, and the pretilt angle of the liquid crystal molecules in one of the first liquid crystal layer or the second liquid crystal layer closer to the protrusions is greater than the pretilt angle of the liquid crystal molecules in the other one of the first liquid crystal layer or the second liquid crystal layer.

9. The LCD panel according to claim 8, wherein each of the protrusions extends in a strip shape, and a shape of a cross section of each of the protrusions perpendicular to an extending direction of the protrusions is one of a trapezoid, a triangle, or a semicircle.

10. The LCD panel according to claim 8, wherein one of the first substrate or the second substrate is provided with a pixel electrode, and the extending direction of the protrusions is same as an extending direction of the pixel electrode.

11. A curved display device, comprising:
a liquid crystal display (LCD) panel; and
a backlight source connected to the LCD panel and providing backlight for the LCD panel; and
wherein the LCD panel comprises:
a first substrate;
a second substrate disposed opposite to the first substrate; and
a liquid crystal layer disposed between the first substrate and the second substrate, the liquid crystal layer comprising a first liquid crystal layer adjacent to the first substrate and a second liquid crystal layer adjacent to the second substrate; and
wherein liquid crystal molecules in the first liquid crystal layer have a first pretilt angle relative to the first substrate, liquid crystal molecules in the second liquid crystal layer have a second pretilt angle relative to the second substrate, and the first pretilt angle and the second pretilt angle are not equal.

12. The curved display device according to claim 11, wherein a difference between the first pretilt angle and the second pretilt angle ranges from 0.5° to 30°; alternatively, the difference between the first pretilt angle and the second pretilt angle ranges from 0.5° to 2°.

13. The curved display device according to claim 11, wherein one of the first pretilt angle or the second pretilt angle ranges from 60° to 89.5°, and the other one of the first pretilt angle or the second pretilt angle is equal to 90°.

14. The curved display device according to claim 11, further comprising a first alignment film and a second alignment film, wherein the first alignment film is disposed on a side surface of the first substrate adjacent to the first liquid crystal layer, and the second alignment film is disposed on a side surface of the second substrate adjacent to the second liquid crystal layer and is disposed opposite to the first alignment film.

15. The curved display device according to claim 14, wherein one of the first alignment film or the second alignment film is defined with grooves on a side surface adjacent to the liquid crystal layer, and the pretilt angle of the liquid crystal molecules in one of the first liquid crystal layer or the second liquid crystal layer closer to the grooves is greater than the pretilt angle of the liquid crystal molecules in the other one of the first liquid crystal layer or the second liquid crystal layer.

16. The curved display device according to claim 15, wherein a depth of each of the grooves is less than or equal to a thickness of the first alignment film or a thickness of the second alignment film.

17. The curved display device according to claim 15, wherein one of the first substrate or the second substrate is provided with pixel electrodes, and an extending direction of each of the grooves is same as an extending direction of each of the pixel electrodes.

18. The curved display device according to claim 14, wherein one of the first substrate or the second substrate is provided with protrusions on a side surface adjacent to the liquid crystal layer, and the pretilt angle of the liquid crystal molecules in one of the first liquid crystal layer or the second liquid crystal layer closer to the protrusions is greater than the pretilt angle of the liquid crystal molecules in the other one of the first liquid crystal layer or the second liquid crystal layer.

19. The curved display device according to claim 18, wherein each of the protrusions extends in a strip shape, and a shape of a cross section of each of the protrusions perpendicular to an extending direction of the protrusions is one of a trapezoid, a triangle, or a semicircle.

20. The curved display device according to claim 18, wherein one of the first substrate or the second substrate is provided with a pixel electrode, and the extending direction of the protrusions is same as an extending direction of the pixel electrode.
